(19) United States
(12) Patent Application Publication
(10) Pub. No.: US 2026/0286846 A1
(43) Pub. Date: Sep. 24, 2026

(54) Steam Powered Electric Generator Device

(71) Applicant: Matthew Shun, Glendale, CA (US)

(72) Inventor: Matthew Shun, Glendale, CA (US)

(21) Appl. No.: 19/269,181

(22) Filed: Jul. 15, 2025

Related U.S. Application Data
(60) Provisional application No. 63/774,184, filed on Mar. 19, 2025.

(51) Int. Cl. F01B 23/10; H02J 7/00; H02K 7/18

(52) U.S. Cl. CPC F01B 23/10; H02J 7/855; H02K 7/1823

(57) ABSTRACT

A steam powered electric generator device is disclosed, which is a portable device for providing electricity without fossil fuel. The steam powered electric generator device comprises a water tank with heating coils that are heated via an internal battery. Once the heating coils are heated, the device produces steam as the water is heated. Steam is then transferred to a valve unit which communicates with a piston. The piston is powered to turn the generator, thus producing electrical energy from the generator. The device can be sized to fit into a 40-foot cargo container for ease of shipping. In another embodiment, the device is sized to fit into vehicles that use electric motors, such as cars, trucks, trains, ships, aircraft with electric motors turning propellers.

### CROSS REFERENCE TO RELATED APPLICATION

The present application claims priority to, and the benefit of, U.S. Provisional Application No. 63/774,184, which was filed on Mar. 19, 2025, and is incorporated herein by reference in its entirety.

### FIELD OF THE INVENTION

The present invention relates generally to the field of steam powered electric generator devices. More specifically, the present invention relates to a steam powered generator capable of producing renewable, environmentally friendly electricity. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in steam powered electric generator devices. Generally, power loss can occur and be exceptionally frustrating if it is out for long periods of time. Homes and businesses reliant on fossil fuels may lose perishable goods and other items if they lack power for several hours or days at a time. Generators powered by gas and other fossil fuels are expensive to maintain and upkeep, along with being harmful to the environment.

Accordingly, there is a demand for an improved steam powered electric generator device that is capable of producing renewable environmentally friendly electricity. More particularly, there is a demand for a steam powered electric generator device that can be hooked up to a power substation to bypass transmission lines that fail during inclement weather conditions.

Therefore, there exists a long-felt need in the art for a steam powered electric generator device that features a water tank, battery, and heating coils that work together to produce steam that powers a piston. There is also a long-felt need in the art for a steam powered electric generator device that allows the piston to rotate the generator and create electricity, ensuring power can be maintained without fossil fuels. Further, there is a long-felt need in the art for a steam powered electric generator device that can be hooked up to a power substation to bypass transmission lines that fail during inclement weather conditions. Moreover, there is a long-felt need in the art for a device that provides users with a steam powered generator capable of producing renewable, environmentally friendly electricity. Further, there is a long-felt need in the art for a steam powered electric generator device that can be sized to fit into a forty-foot cargo container for ease of shipping. Finally, there is a long-felt need in the art for a steam powered electric generator device that can be sized to fit into vehicles that use electric motors, such as cars, trucks, trains, ships, aircraft, etc.

The subject matter disclosed and claimed herein, in one embodiment thereof, comprises a steam powered electric generator device. The device is a portable system for providing electricity without fossil fuel. The steam powered electric generator device comprises a water tank with heating coils that are heated via an internal battery. Once the heating coils are heated, the device produces steam as the water is heated. Steam is then transferred to a valve unit which communicates with a piston. The piston is powered to turn the generator, thus producing electrical energy from the generator. The device can be sized to fit into a 40-foot cargo container for ease of shipping. In another embodiment, the device is sized to fit into vehicles that use electric motors, such as cars, trucks, trains, ships, aircraft with electric motors turning propellers.

In this manner, the steam powered electric generator device of the present invention accomplishes all of the forgoing objectives and provides users with a device that can be hooked up to a substation to bypass transmission lines that fail under poor weather conditions. The device provides electricity without fossil fuels. The device can come in different sizes depending on need.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a steam powered electric generator device. The device is a portable system for providing electricity without fossil fuel. The steam powered electric generator device comprises a water tank with heating coils that are heated via an internal battery. Once the heating coils are heated, the device produces steam as the water is heated. Steam is then transferred to a valve unit which communicates with a piston to turn a generator to produce energy.

In one embodiment, the steam powered electric generator device provides users with a steam powered generator capable of producing renewable environmentally friendly electricity. The device can be hooked up to a power substation to bypass transmission lines that fail during inclement weather conditions. Conventional generators powered by gas and other fossil fuels are expensive to maintain and upkeep, along with being harmful to the environment. However, the steam powered electric generator device provides electricity without fossil fuel.

In one embodiment, the steam powered electric generator device comprises a water tank with heating coils. The water tank can be any suitable shape and size as is known in the art, depending on the wants and/or needs of a user. Typically, the water tank is rectangular in shape but can be square, as well. The water tank has an open cavity for accepting a certain amount of water, to be retained within the tank. Further, positioned at the bottom of the water tank is a plurality of heating coils for heating the water with the tank. Any suitable heating coils can be utilized as is known in the art. And any suitable number of heating coils can be utilized as well.

In one embodiment, the plurality of heating coils are heated via an internal battery. Typically, the battery is a rechargeable battery but could also be a replaceable battery, as well. The battery acts to provide power to the heating coils which heat up to then heat the water retained within the tank.

In one embodiment, once the water retained within the water tank is heated, the water produces steam. Once steam builds up to a certain point, the steam is then transferred to a valve unit which communicates with a piston. The valve and piston are conventional valve and pistons, as is known in the art.

In one embodiment, the piston is powered to turn the generator. Specifically, linear motion from the piston turns the generator to create electrical energy. Further, the valve opens and allows steam into the piston on one side and pushes the flat piston head to move the piston arm. The valve then turns off and opens a vent to release steam. Then, the valve opens and allows steam on the other side of the piston head to build up, which pushes the flat piston head to move the piston arm back. The valve then turns off and opens a vent to release steam. Thus, the piston arm moves back and forth (i.e., slides), as steam is applied to either side of the piston. Further, the piston arm connects to a translational member or cam to translate the linear motion of the piston arm to rotational motion to turn the generator, thus producing electrical energy from the generator.

In one embodiment, the generator is a conventional generator as is known in the art and acts to create electrical energy from rotational motion.

In one embodiment, the device can be sized to fit into a 40-foot cargo container for ease of shipping.

In another embodiment, the device is sized to fit into vehicles that use electric motors, such as cars, trucks, trains, ships, aircraft with electric motors turning propellers, etc., or any other suitable vehicle as is known in the art.

In yet another embodiment, the steam powered electric generator device comprises a plurality of indicia.

In yet another embodiment, a method of producing energy via steam is disclosed. The method includes the steps of providing a steam powered electric generator device comprising a water tank with heating coils and an internal battery. The method also comprises heating the coils with the internal battery. Further, the method comprises producing steam as the water is heated. The method also comprises transferring the steam to a valve unit which communicates with a piston. The method comprises powering the piston to turn the generator. Finally, the method comprises producing electrical energy from the generator.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the steam powered electric generator device of the present invention in accordance with the disclosed architecture;

FIG. 2 illustrates a perspective view of one embodiment of the steam powered electric generator device of the present invention showing the water tank, battery, and valve in accordance with the disclosed architecture;

FIG. 3 illustrates a perspective view of one embodiment of the steam powered electric generator device of the present invention showing the water tank heated by the battery in accordance with the disclosed architecture;

FIG. 4 illustrates a perspective view of one embodiment of the steam powered electric generator device of the present invention showing the steam produced by the generator in accordance with the disclosed architecture;

FIG. 5 illustrates a perspective view of one embodiment of the steam powered electric generator device of the present invention showing the generator producing power via the piston in accordance with the disclosed architecture; and

FIG. 6 illustrates a flowchart showing the method of producing energy via steam in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a steam powered electric generator device that features a water tank, battery, and heating coils that work together to produce steam that powers a piston. There is also a long-felt need in the art for a steam powered electric generator device that allows the piston to rotate the generator and create electricity, ensuring power can be maintained without fossil fuels. Further, there is a long-felt need in the art for a steam powered electric generator device that can be hooked up to a power substation to bypass transmission lines that fail during inclement weather conditions. Moreover, there is a long-felt need in the art for a device that provides users with a steam powered generator capable of producing renewable, environmentally friendly electricity. Further, there is a long-felt need in the art for a steam powered electric generator device that can be sized to fit into a forty-foot cargo container for ease of shipping. Finally, there is a long-felt need in the art for a steam powered electric generator device that can be sized to fit into vehicles that use electric motors, such as cars, trucks, trains, ships, aircraft, etc.

The present invention, in one exemplary embodiment, is a novel steam powered electric generator device. The device is a portable system for providing electricity without fossil fuel. The steam powered electric generator device comprises a water tank with heating coils that are heated via an internal battery. Once the heating coils are heated, the device produces steam as the water is heated. Steam is then transferred to a valve unit which communicates with a piston. The piston is powered to turn the generator, thus producing electrical energy from the generator. The present invention also includes a novel method of producing energy via steam. The method includes the steps of providing a steam powered electric generator device comprising a water tank with heating coils and an internal battery. The method also comprises heating the coils with the internal battery. Further, the method comprises producing steam as the water is heated. The method also comprises transferring the steam to a valve unit which communicates with a piston. The method comprises powering the piston to turn the generator. Finally, the method comprises producing electrical energy from the generator.

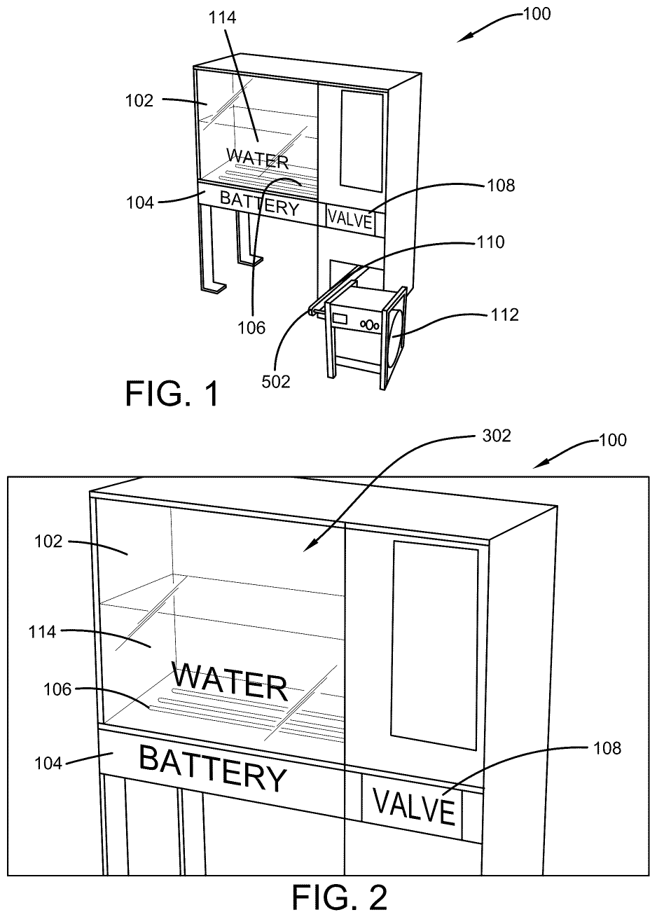

Referring initially to the drawings, FIG. 1 illustrates a perspective view of one embodiment of the steam powered electric generator device 100 of the present invention. In the present embodiment, the steam powered electric generator device 100 is an improved steam powered electric generator device 100 that provides a user with a portable device for providing electricity without fossil fuel. Specifically, the steam powered electric generator device 100 comprises a water tank 102, an internal battery 104, and heating coils 106. Once the heating coils 106 are heated, the water 114 produces steam 116 as the water 114 is heated. Steam 116 is then transferred to a valve unit 108 which communicates with a piston 110 to turn a generator 112 to produce energy.

Generally, the steam powered electric generator device 100 provides users with a steam powered generator capable of producing renewable environmentally friendly electricity. The device 100 can be hooked up to a power substation to bypass transmission lines that fail during inclement weather conditions. Conventional generators powered by gas and other fossil fuels are expensive to maintain and upkeep, along with being harmful to the environment. However, the steam powered electric generator device 100 provides electricity without fossil fuel.

As shown in FIG. 2, the device 100 can be sized to fit into a 40-foot cargo container for ease of shipping. Further, the steam powered electric generator device 100 can be sized up or down depending on the needs and/or wants of a user, and for ease of transport.

Furthermore, in another embodiment, the device 100 is sized to fit into vehicles that use electric motors, such as but not limited to cars, trucks, trains, ships, aircraft with electric motors turning propellers, etc., or any other suitable vehicle as is known in the art.

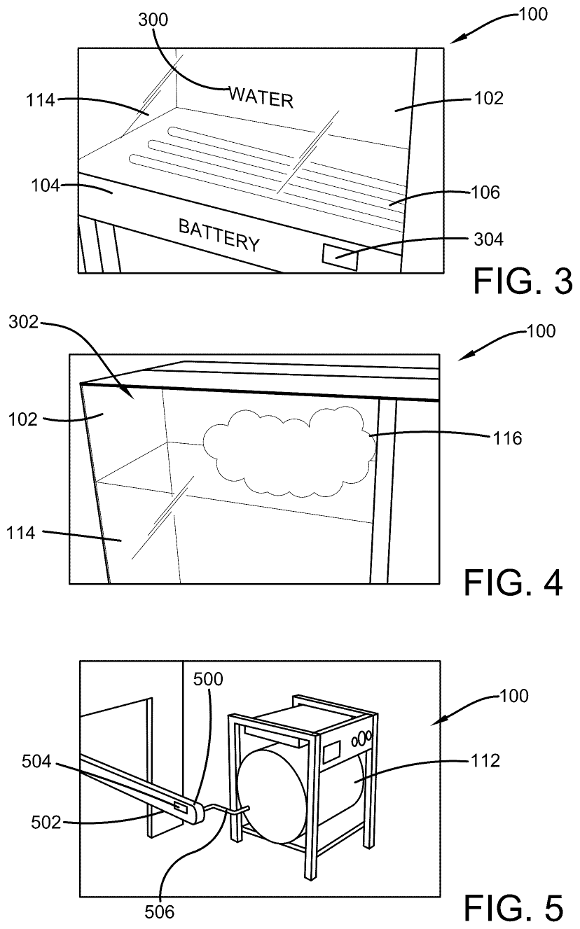

As shown in FIG. 3, the steam powered electric generator device 100 comprises a water tank 102 with heating coils 106. The water tank 102 can be any suitable shape and size as is known in the art, depending on the wants and/or needs of a user. Typically, the water tank 102 is rectangular in shape but can be square or other shapes, as well. The water tank 102 has an open cavity 302 for accepting a certain amount of water 114, to be retained within the tank 102. Further, positioned at the bottom of the water tank 102 is a plurality of heating coils 106 for heating the water 114 within the tank 102. Any suitable heating coils 106 can be utilized as is known in the art. And any suitable number of heating coils 106 can be utilized as well.

In one embodiment, the steam powered electric generator device 100 comprises a plurality of indicia 300. The water tank 102 of the device 100 may include advertising, a trademark, or other letters, designs, or characters, printed, painted, stamped, or integrated into the water tank 102, or any other indicia 300 as is known in the art. Specifically, any suitable indicia 300 as is known in the art can be included, such as but not limited to, patterns, logos, emblems, images, symbols, designs, letters, words, characters, animals, advertisements, brands, etc., that may or may not be generator, water tank, or brand related.

Furthermore, the plurality of heating coils 106 are heated via an internal battery 104. Typically, the battery 104 is a rechargeable battery but could also be a replaceable battery, as well. The battery 104 acts to provide power to the heating coils 106 which heat up to then heat the water 114 retained within the tank 102. The battery 104 may be a disposable battery or a rechargeable battery in the form of an alkaline, nickel-cadmium, nickel-metal hydride battery, etc., such as any 3V-12volts DC battery or other conventional battery, such as A, AA, AAA, etc., that supplies power to the steam powered electric generator device 100. Throughout this specification, the term “battery” may be used interchangeably to refer to one or more wet or dry cells or batteries of cells in which chemical energy is converted into electricity and used as a source of DC power. References to recharging or replacing the battery 104 may refer to recharging or replacing individual cells, individual batteries of cells, or a package of multiple battery cells as is appropriate for any given battery technology that may be used. In addition, a rechargeable embodiment of the battery 104 may be recharged using a USB port 304, wherein the USB port 304 is a USB-A, USB-B, Micro-B, Micro-USB, Mini-USB, or USB-C port, etc.

As shown in FIG. 4, once the water 114 retained within the water tank 102 is heated, the water 114 produces steam 116. Once steam 116 builds up to a certain point, the steam 116 is then transferred to a valve unit 108 which communicates with a piston 110. The valve 108 and piston 110 are conventional valve and pistons, as is known in the art.

As shown in FIG. 5, the piston 110 is powered to turn the generator 112. Specifically, linear motion from the piston 110 turns the generator 112 to create electrical energy. Further, the valve 108 opens and allows steam into the piston 110 on one side and pushes the flat piston head 500 to move the piston arm 502. The valve 108 then turns off and opens a vent 504 to release steam 116. Then, the valve 108 opens and allows steam 116 on the other side of the piston head 500 to build up, which pushes the flat piston head 500 to move the piston arm 502 back. The valve 108 then turns off and opens a vent 504 to release steam 116. Thus, the piston arm 502 moves back and forth (i.e., slides), as steam 116 is applied to either side of the piston 110. Further, the piston arm 502 connects to a translational member 506 or cam to translate the linear motion of the piston arm 502 to rotational motion to turn the generator 112, thus producing electrical energy from the generator 112.

Further, the generator 112 can be any conventional generator as is known in the art and acts to create electrical energy from rotational motion. Any suitable generator 112 can be utilized with the device 100 as is known in the art.

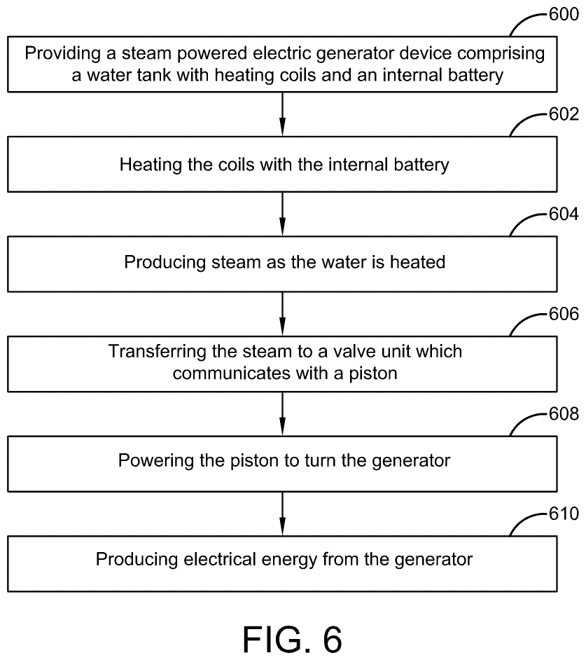

FIG. 6 illustrates a flowchart of the method of producing energy via steam. The method includes the steps of at 600, providing a steam powered electric generator device comprising a water tank with heating coils and an internal battery. The method also comprises at 602, heating the coils with the internal battery. Further, the method comprises at 604, producing steam as the water is heated. The method also comprises at 606, transferring the steam to a valve unit which communicates with a piston. The method comprises at 608, powering the piston to turn the generator. Finally, the method comprises at 610, producing electrical energy from the generator.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “steam powered electric generator device”, “steam powered device”, “electric generator device”, and “device” are interchangeable and refer to the steam powered electric generator device 100 of the present invention.

Notwithstanding the foregoing, the steam powered electric generator device 100 of the present invention can be of any suitable size and configuration as is known in the art without affecting the overall concept of the invention, provided that it accomplishes the above stated objectives. One of ordinary skill in the art will appreciate that the steam powered electric generator device 100 as shown in FIGS. 1-6 is for illustrative purposes only, and that many other sizes and shapes of the steam powered electric generator device 100 are well within the scope of the present disclosure. Although the dimensions of the steam powered electric generator device 100 are important design parameters for user convenience, the steam powered electric generator device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A steam powered electric generator device that provides a user with a portable device for providing electricity without fossil fuel, the steam powered electric generator device comprising:
a water tank;
an internal battery; and
heating coils; and
wherein the heating coils are powered by the internal battery;
wherein the heating coils then heat water within the water tank to produce steam; and
further wherein the steam communicates with a piston to turn a generator to produce energy.

2. The steam powered electric generator device of claim 1, wherein the water tank is rectangular in shape and comprises an open cavity for retaining water.

3. The steam powered electric generator device of claim 2, wherein the heating coils are positioned at a bottom of the water tank.

4. The steam powered electric generator device of claim 3 further comprising a plurality of indicia.

5. The steam powered electric generator device of claim 4, wherein the internal battery may be a disposable battery or a rechargeable battery that supplies power to the steam powered electric generator device.

6. The steam powered electric generator device of claim 5, wherein if the internal battery is a rechargeable battery, the rechargeable battery is recharged using a USB port.

7. The steam powered electric generator device of claim 6, wherein once steam produced from the water heated within the water tank builds up, the steam is then transferred to a valve unit which communicates with the piston.

8. The steam powered electric generator device of claim 7, wherein the linear motion from the piston turns the generator to create electrical energy.

9. The steam powered electric generator device of claim 8, wherein the valve unit opens and allows steam into the piston on one side and pushes a flat piston head to move a piston arm.

10. The steam powered electric generator device of claim 9, wherein the valve unit then turns off and opens a vent to release steam.

11. The steam powered electric generator device of claim 10, wherein the valve opens and allows steam on other side of the flat piston head to build up, which pushes the flat piston head to move the piston arm back.

12. The steam powered electric generator device of claim 11, wherein the valve unit then turns off and opens a vent to release steam.

13. The steam powered electric generator device of claim 12, wherein the piston arm moves back and forth, as steam is applied to either side of the piston.

14. The steam powered electric generator device of claim 13, wherein the piston arm connects to a translational member to translate linear motion of the piston arm to rotational motion to turn the generator.

15. A steam powered electric generator device that provides a user with a portable device for providing electricity without fossil fuel, the steam powered electric generator device comprising:
a water tank which is rectangular in shape and comprises an open cavity for retaining water;
an internal battery; and
heating coils positioned at a bottom of the water tank;
wherein the heating coils are powered by the internal battery;
wherein the heating coils then heat water within the water tank to produce steam;
wherein once steam produced from the water heated within the water tank builds up, the steam is then transferred to a valve unit which communicates with the piston;
wherein linear motion from the piston turns the generator to create electrical energy;
wherein the valve unit opens and allows steam into the piston on one side and pushes a flat piston head to move a piston arm;
wherein the valve unit then turns off and opens a vent to release steam;
wherein the valve opens and allows steam on other side of the flat piston head to build up, which pushes the flat piston head to move the piston arm back;
wherein the valve unit then turns off and opens a vent to release steam;
wherein the piston arm moves back and forth, as steam is applied to either side of the piston; and
further wherein the piston arm connects to a translational member to translate linear motion of the piston arm to rotational motion to turn the generator and produce electricity.

16. The steam powered electric generator device of claim 15, wherein the steam powered electric generator device can be sized to fit into a 40-foot cargo container for ease of shipping.

17. The steam powered electric generator device of claim 15, wherein the steam powered electric generator device is sized to fit into vehicles that use electric motors, such as cars, trucks, trains, ships, or aircraft with electric motors turning propellers.

18. The steam powered electric generator device of claim 15, wherein the internal battery may be a disposable battery or a rechargeable battery that supplies power to the steam powered electric generator device.

19. The steam powered electric generator device of claim 18, wherein if the internal battery is a rechargeable battery, the rechargeable battery is recharged using a USB port.

20. A method of producing energy via steam, the method comprising the following steps:
providing a steam powered electric generator device comprising a water tank with heating coils and an internal battery;
heating the coils with the internal battery;
producing steam as the water is heated;
transferring the steam to a valve unit which communicates with a piston;
powering the piston to turn the generator; and
producing electrical energy from the generator.
